(19) United States
(12) Patent Application Publication
(10) Pub. No.: US 2007/0240182 A1
(43) Pub. Date: Oct. 11, 2007

(54) Methods and apparatus for providing a guide and/or remote control suitable for children

(76) Inventor: John Callahan, Broomfield, CO (US)

Correspondence Address: STRAUB & POKOTYLO, 620 TINTON AVENUE, BLDG. B, 2ND FLOOR, TINTON FALLS, NJ, 07724, US

(21) Appl. No.: 11/402,261

(22) Filed: Apr. 10, 2006

(51) Int. Cl. G06F 13/00

(52) U.S. Cl. 725/30; 725/37

(57) ABSTRACT

Methods and apparatus for generating program guides and restricting access to programs as a function of program ratings and/or program content are described. Methods of billing for services are also described. Multiple remote controls, e.g., of different types or assigned different identifiers are used. Access to program guide content and actual program content is restricted based on which remote control device is used. Program guide content and program access can be restricted based on a rating level and/or particular attributes of the program, e.g., sex, violence, adult language. For example PG-13 programs with sexual content may be restricted while PG-13 programs with violent content may be allowed to be viewed depending on what restrictions are set. Program attributes may be included in program guide information. Remotes used to provide restricted access may use different control signals from remotes used to provide unrestricted access and can be implemented as simplified remotes.

### FIELD OF THE INVENTION

The present invention relates to television services and, more particularly, to methods and apparatus for providing television guides at least some of which are intended for viewing by children.

### BACKGROUND OF THE INVENTION

There is a growing concern that young children may be exposed to program content which is not suitable for the child's age group or level of maturity.

In order to help parents make informed decisions about what programs may be suitable for their children to watch, movies and television programs are often rated according to their content. Common ratings currently in use include TV ratings, such as TV Y, TV Y7, TV G, TV PG, TV 14 and TV MA and movie ratings such as G, PG, PG-13, R, X, XXX, with the ratings listed in order of increasing amounts of mature content.

Cable and various other types of entertainment service providers are beginning to provide movie and TV rating information as part of their program guides. Accordingly, a parent can review program guide information and make decisions about which programs and/or movies are suitable for their children to watch.

Most cable set top boxes and satellite receivers offer the ability to lock out certain channels and require entry of a code, e.g., set by the parent, before the locked out channels can be accessed. While manually locking out particular channels can be effective for limiting access to adult sex channels or other channels which have nothing but content intended for mature audiences, some channels offer a mix of programs some of which may be suitable for young viewers while others may not be. It becomes difficult with respect to channels having a mix of content for a parent to continually review and decide on a per program basis when the channel should be blocked and when programs suitable for their children are being presented.

Entry of codes to control access to particular channels often becomes inconvenient as children may learn the lock out code through trial and error or other means and frequent changing of the code can make it difficult for the parent to remember the lock out code needed to be entered to provide them access to the adult oriented channels.

While denying a child access to a particular channel deemed to have unsuitable content can be effective at preventing a child from seeing the undesirable content, if the particular adult program appears on the television guide which is viewable by the child, the child may be motivated to take steps to defeat the parental lock out in order to try and watch the adult program listed in the guide.

From the above discussion, it should be apparent that it would be beneficial if a method could be developed where adult viewers could be presented with a complete menu of program options while younger viewers could be presented with a more limited guide including only programs and other content suited for their particular age group or level of maturity. It would be further desirable if adults were allowed to view adult and other mature content programs without having to enter a code to override a channel or program lock out while less mature members of the family were denied access to such channels. From a service providers perspective, it would be highly desirable if providing a convenient way of implementing parental controls could be used to produce revenue while, at the same time, providing parents with the socially desirable benefits of being able to restrict child access to mature program content.

### SUMMARY OF THE INVENTION

The present invention is directed to improved methods of presenting program guides and to methods of restricting access to channels as a function of program and/or program guide content.

The invention is also directed to methods of providing parental control and billing for services, e.g., user friendly parental control services which allow a parent to, e.g., in some embodiments update program screening information over the Internet via a Web based interface. In accordance with some embodiments of the invention a service subscriber may be billed an additional monthly charge for being provided a restricted access remote, e.g., intended for use by children, in addition to an unrestricted access remote and/or for being provided the ability to control program screening over the Internet.

The restricted access remote, used in various embodiments of the invention, may be a simplified easier to use remote with less buttons than the full access remote and/or larger buttons which are easier to identify and press. Thus, in accordance with various embodiments of the invention, multiple remote controls, e.g., of different types or assigned different identifiers are used to provide different levels of access to program information and/or programs.

Program guide information may include for each program, in addition to a program rating, content information. Program rating information may be in the form of a rating such as TV Y, TV Y7, TV G TV PG, TV 14, TV MA, listed in increasing order of mature content. Content information may be in the form of, e.g., a single letter or two letter label, providing information about the content of the program, e.g., whether it includes violence (V), sexual content (S), coarse or crude indecent language (L), suggestive dialogue (D), or fantasy violence (FV), etc.

In various embodiments, access to program guide content and actual program content is restricted based on which remote control device is used. Program guide content and program access can be restricted based on a rating and/or particular content of the program, e.g., sex, violence, adult language. For example PG programs with sexual content may be restricted while PG programs with violent content may be allowed to be viewed depending on what restrictions are set. Program attributes may be included in program guide information. Remotes used to provide restricted access may use different control signals from remotes used to provide unrestricted access and may, but need not be implemented as simplified remotes.

Program guide presentation and program access control devices, referred to herein as “presentation control devices”, are common place. Examples of presentation control devices include set top boxes, satellite receivers, and television receivers with the ability to display one or more program guides and implement some form of access control, e.g., a channel lock out feature.

For purposes of explaining the invention, the novel program guide and program access control features of the invention will be described in the exemplary embodiment of a cable set top box (STB) used to present cable program guides and to control access to various programs which may be available from a cable network. However, the methods and apparatus of the present invention are equally applicable to presentation control devices used for providing access to satellite programs, pre-recorded program content, etc. for which program guide information is available. Accordingly, while a set top box is used to explain the invention, is should be appreciated that the invention is not limited to set top box applications.

In various embodiments of the invention, users of a set top box, capable of displaying program guides and controlling program access, are provided with multiple remotes. The number and type of remotes provided is tracked and the subscriber may be billed accordingly, e.g., with users of remotes of different types intended to support the program guide and access features of the invention being charged a different amount than subscribers who do not use multiple remotes of different types.

In various embodiments where different types of remotes are used, at least two types of remotes are provided, e.g., a first type intended for unrestricted program access and/or control and a second type intended to be used for restricted program access. The remotes may use different control codes and/or transmit a remote control identifier allowing the set top box to identify the type of remote transmitting to the set top box.

In some embodiments, the set top box determines the type of remote from the type of signal received with the different types of remotes using different signals or signal codes, to implement one or more functions, e.g., a guide request function, number entry function and up/down channel function. In other embodiments, at least one of the remote controls transmits a remote identifier signal in addition to control command signals so that a remote designated to provide restricted program access can be distinguished from a remote which is designated to provide unrestricted program access even if the remotes are the same model or design.

The set top box responds to program guide display requests from unrestricted access type remotes by displaying the full array of programming content which is available. This may include adult content programs, pay per view programs, shopping programs, etc.

The set top box responds to program guide display requests from restricted access type remotes by displaying a limited array of programming content information, e.g., a particular program package which may be a child program package, programs corresponding to a particular ratings group, e.g., PG-13 or lower, with adult or R rated programs being excluded, and/or with programs having a particular content, e.g., sexual content, being excluded.

In accordance with various embodiments of the invention, the user of the restricted access type remote is not shown on the presented guide any channels or programs which are determined as being outside the permitted ratings group(s) which the restricted access type remote is permitted to access. In this manner, the user of the restricted access type remote is keep from being made aware of the full variety of programs available to the user of the unrestricted type remote.

As can be appreciated, by filtering the guide to remove programs from being listed which the user of the restricted remote is not allowed to access, the restricted user is less likely to be curious about the particular programs and/or content which they are being restricted from accessing. In addition, by presenting the restricted program guide to the restricted users, adults or other members of the household may not have to explain or justify to the restricted users why they are purchasing access to channels having adult content or violent material while denying access to the same material to the restricted users.

Users of the unrestricted remote can configure what content/programs restricted users are allowed to access using the restricted remote control. Alternatively, rather than set restrictions using the unrestricted remote control, the cable company may configure the restrictions from the cable head-end by signaling the filtering parameters to be used in filtering programs and guide displays to be presented to a user of the restricted remote control. In some embodiments the user is allowed to update restriction information via a Web interface and the updated restrictions are then downloaded to the user's set top box. Such web based restriction updates via a Web server located at the head end can be used even if the restricted remote device is not used, e.g., with more conventional ways of restricting access such are requiring entry of a personal identification number (PIN) prior to allowing unrestricted access to programs once the set top box is placed in a restricted mode of operation.

The set top box can implement the filtering guide and program presentation not only at a channel level but, in some embodiments, on the program level, e.g., with individual programs being restricted based on their content even if the rating assigned the program falls within a range of acceptable program ratings. In various embodiments, the set top box includes a filter module which provides the capability for filtering programs and guide information based on program rating information included in program guide information electronically communicated to the set top box, e.g., from the cable head end.

Various additional features and advantages of the present invention will be apparent from the detailed description which follows.

### BRIEF DESCRIPTION OF THE DRAWINGS

FIG. 1 illustrates an exemplary system implemented in accordance with the present invention.

FIG. 2 illustrates am exemplary STB, which can be used in the system of FIG. 1.

FIG. 3, which comprises the combination of FIGS. 3A and 3B, illustrates a flowchart showing steps performed by an exemplary set top box in accordance with the invention.

FIG. 4 illustrates a flowchart showing steps, including billing steps, performed by the cable head end when implementing an exemplary method of providing service in accordance with the invention.

FIG. 5 illustrates an exemplary unrestricted program guide which may be displayed in accordance with the invention.

FIGS. 6-8 illustrate various exemplary restricted program guides which may be generated and displayed in accordance with the invention when the filtering constraints shown in each of the figures is applied to the information used to generate the unrestricted program guide shown in FIG. 5.

### DETAILED DESCRIPTION

As discussed above, the present invention is directed to methods and apparatus for program guides and restricting access to programs as a function of program ratings and/or program content are described.

Various features of the invention will now be described with reference to the figures which show exemplary apparatus and methods implemented in accordance with the invention.

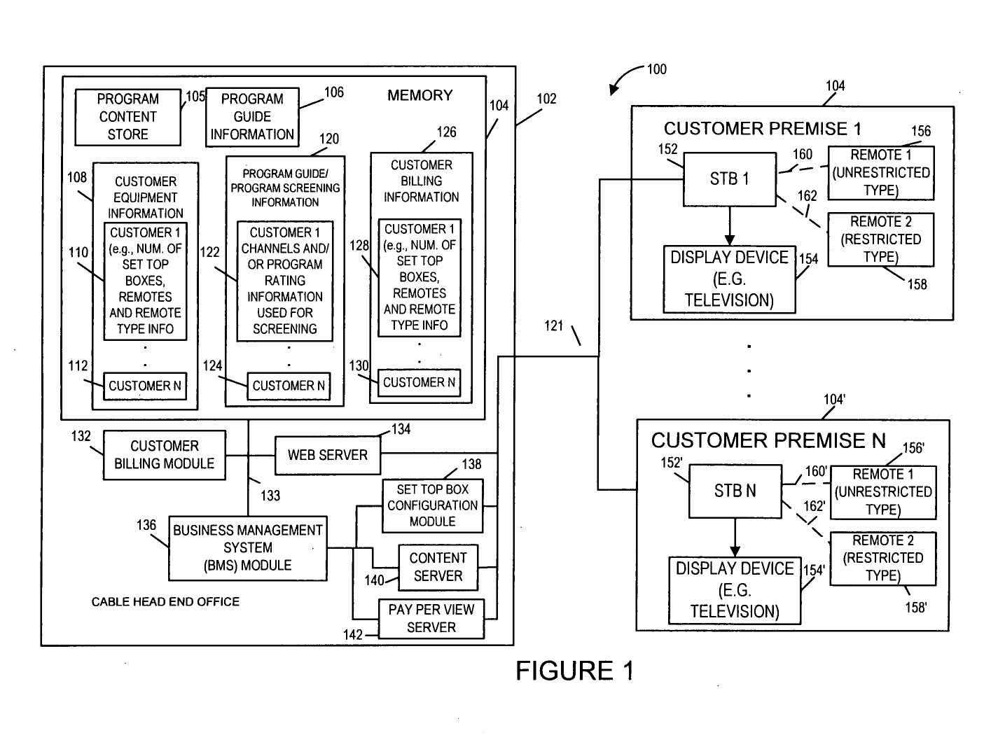

FIG. 1 illustrates a communications system 100, e.g., a cable system, implemented in accordance with one embodiment of the exemplary invention. It should be appreciated that the program guide and screening methods of the present invention are not limited to set top box applications but can be used in satellite decoders and systems as well as other systems where program guide and/or programs may be displayed.

The exemplary cable system 100 includes a cable office 102 which is coupled to a plurality of N customer premises 104 through 104′ via cable 121. Each customer premise 104, 104′ corresponds to a different physical location and includes a corresponding STB 152, 152′. The STBs 152, 152′ are coupled to corresponding display devices 154, 154′, respectively. The display devices may be, for example, television sets, monitors or some other form of display which can be used to display images supplied by the set top box 152, 152′. The images to be displayed may include program guides generated in accordance with the invention.

The cable office 102 serves as a distribution point for television shows and corresponding program guide information which can be displayed under direction of the STB 152, 152′, e.g., in response to the STB 152 or 152; receiving a signal commanding it to display program guide information.

In accordance with the present invention, subscribers corresponding to customer premises 1 104, N 104′ are issued multiple remotes which are designated for providing different levels of access to program guide information and/or programs. A first remote 156, 1561, issued for use at the first and Nth customer premises respectively, which provide, e.g., unrestricted access to program information and program content, and second remotes 158, 158′ which are used to obtain restricted access to program guide information and/or program content. The remotes 156, 158 may be of different types which use different signals 160, 162 to convey commands, e.g., different infrared signals may be used by remote 156, 158 to instruct the STB 152 to display a program guide. Thus, in some embodiments, the particular type of signal used as a command to display a program guide can be used to determine if the user of the remote is to be provided an unrestricted program guide or a restricted program guide. In other embodiments, remote control 156, 158 may be the same physical type of remote but with at least one of the remotes being programmed to transmit an identifier signal in addition to a command, e.g., the display program guide command. In such an embodiment, the remote control identifier portion of a received signal can be used by the STB 152 to distinguish between a remote used to provide a subscriber unrestricted access and a remote which used to provide restricted access to program information and/or programs. Remote 158, which is designated to be used for obtaining restricted access may, but need not be, implemented as a simplified remote, e.g., a child friendly remote, with fewer buttons and/or larger buttons making use by children easier.

The cable office 102 in the exemplary system 100 includes a memory 104, customer billing module 132, a WEB server 134, business management system module 136, content server 140, pay per view server 142, and a set top box configuration module 138 which are coupled together and to the memory 104 by a bus 133.

The memory 104 includes a program content store 105 including, e.g., TV programs, and program guide information 106. Program guide information 106 includes information such as schedule presentation time, title, program rating, and one or more program content indicators in addition to the program rating.

The memory 104 also includes, on a per customer, e.g., subscriber, basis customer equipment information 108, program guide and/or program screening information 120 and customer billing information 126.

Customer equipment information 108 includes, for each customer, information 110, 112, on a per customer basis, about the type of service provided, the number of set top boxes rented to the subscriber, the number of remotes provided to the subscriber, which of the remotes are designated for unrestricted access and which if any are designated for providing restricted access and/or whether the subscriber is being provided a service feature which allows the subscriber to update program information and program screening via the Internet, e.g., by making a connection to Web server 134. Billing can be performed using the customer equipment information, e.g., with customers being billed as a function of whether they are provided both restricted access type remotes in addition to unrestricted access type remotes. In addition billing can be based on whether the subscriber also subscribes to the Web update feature. Billing information may also include the customer billing information 126 which includes a copy of the customer equipment information which is used for billing as well as other information, e.g. information about pay per view movies ordered, etc. Customer billing information 126 includes, for each customer, billing information on a per customer basis, customer 1 billing information 128, customer N billing information 130.

Program guide and/or program screening information 120 includes information 122, 124, on a per customer basis, used to implement program information and/or program access screening. While in this example the information is shown in the memory 104, the same of similar information is stored in the subscriber's set top box and used by the set top box to implement filtering in accordance with the invention, e.g., when a remote designated for use in obtaining restricted access to information or programs is used by a person at the customer's premises. The screening information may indicate, e.g., particular channels to be blocked, a television or move rating level to be used in determining what content to exclude, and content indicators indicating particular content that should be screened and eliminated, e.g., sexual content, violence, suggestive language, etc. Which filtering parameters are set is generally up to the customer with the customer being provided the option of providing one or more constraints to be used in the filtering processing when the set top box at the subscriber's customer's premise is operating in a restricted access mode of operation.

Customer billing module 132 is responsible for generating, printing and sending bills to customers based on the services provided, e.g., the number and types of remotes and/or other information included in the subscriber's customer billing information record 128 or 130. Business management system module 136 is responsible for initial configuration of subscriber services and the set up and maintenance of subscriber records in memory 104. Web server 134 can be used to access billing and program screening information and to make changes to the subscriber's program screening information.

The set top box configuration module 138, content server 140 and pay per view server 142 are coupled to cable 121 and can send information to one or more of the set top boxes 152, 152′ over the cable 121. The set top box configuration module 138 can send filtering information to particular STB's over the cable connection 121 and is responsible for downloading initial sets of subscriber filter information and for transmitting updated sets of filter information, e.g., when a subscriber updates to program information and content restrictions to be applied in cases of restricted access, e.g., via the WEB server 134 and an Internet connection. Web server 134 is coupled to the cable 121 which may be used as an Internet connection in addition to communicating video content. By interacting with Web Sever 134 a user can update subscriber information stored in memory 104, access billing information, and/or change program rating and other information stored in memory 104 to be used in filtering program guides and/or restricting program access by the set top box 152 or 152′ corresponding to the individual subscriber.

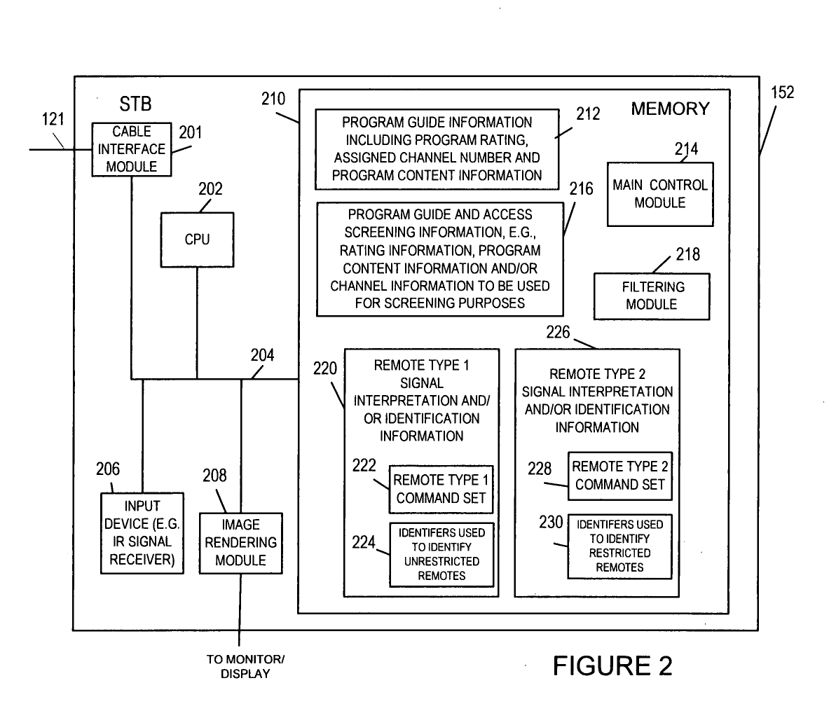

The set top box is responsible for implementing the program guides, programs and program restrictions set by the subscriber. Referring now to FIG. 2, an exemplary set top box 152 which may be used in the system of FIG. 1 is shown in detail.

As shown in FIG. 2, the set top box 152 includes a cable interface module 201, a CPU 202, an input device 206, e.g., IR signal receiver, an image rendering module 208 and a memory 210 which are coupled together by bus 204.

The cable interface module 201 allows the set top box 152 to receive programs, program guide information, configuration information and other information via the cable 121 and to send information to the cable head end. The signal to the cable head end may be implemented via an Internet over cable connection in some embodiments. The input device 206 is responsible for receiving signals, e.g., infrared signals, from one or more remote control devices and converting them to electrical signals which can then be processed by CPU 202. Image rendering module 208 is responsible for converting program guide information to be displayed, programs to be displayed and other information to be displayed, into a format which can be displayed as one or more viewable images on a display device or monitor.

The CPU 202 controls the general operation of the set top box 152, including the generation and outputting of program guide information and/or programs for display. The CPU 202 operates under control of one or more of the modules included in memory 210 using the information and data stored in the memory 210.

The memory 210 includes program guide information 212 which includes, e.g., scheduled program presentation time, program rating information, program content information used to supplement the general rating information. The information may be obtained from general TV guide information supplied to the set top boxes. The rating and content indicator information may be in a standardized format with one or two letter codes being used to indicate particular type of program content which may be of interest from a parental control perspective.

The memory 210 also includes a main control module 214, filtering module 218, program guide and access screening information 216, and remote type signal interpretation and/or identification information 220, 226 for each of a first and second remote 156, 158 respectively which are to be used in providing different levels of access to program information and/or programs depending on which remote is used.

The main control module 214 is responsible for general operation of the set top box 152 and calls the filtering module 218 when filtering of program guide information and/or restrictions on program access is to be implemented based on the screening information 216.

The remote type 1 signal interpretation and/or identification information 220 includes information which can be used to determine if a received signal is from a remote which is to be used in obtaining a first level of access, e.g., unrestricted content access. The information 220 includes a remote type 1 command set 222 and/or a remote command identifier 224 used to identify the first remote 156. The remote type 2 signal interpretation and/or identification information 226 includes information which can be used to determine if a received signal is from a remote which is to be used in obtaining a second level of access, e.g., a restricted level of access to program information and/or programs. The information 226 includes a second remote type command set 228 and/or a second remote command identifier 230 used to identify the second remote 158.

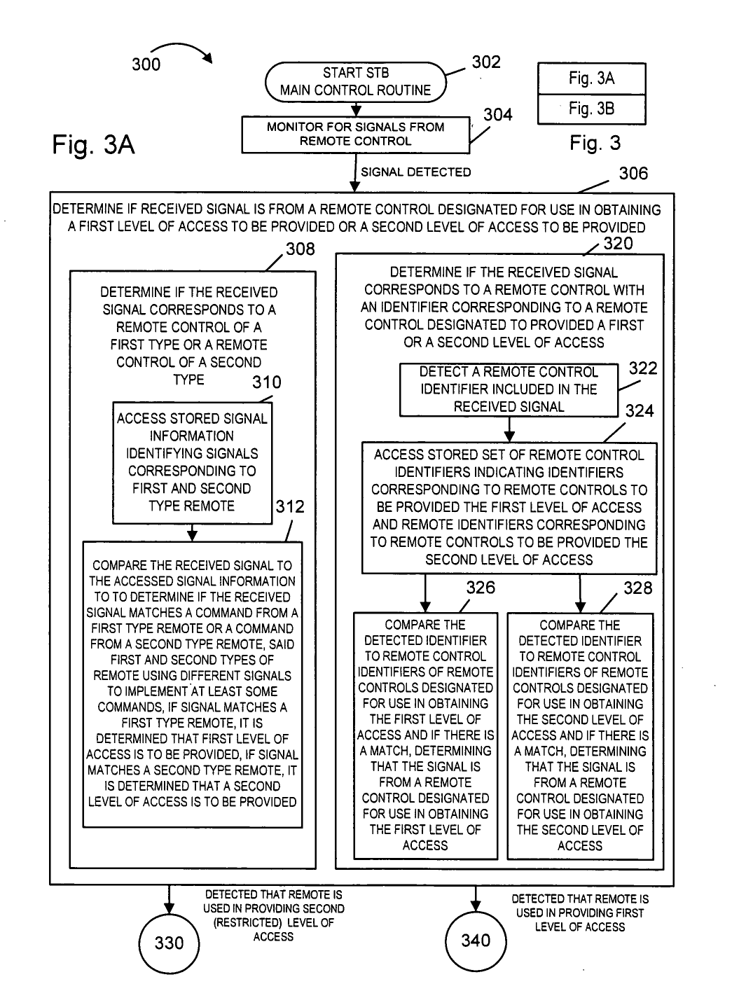

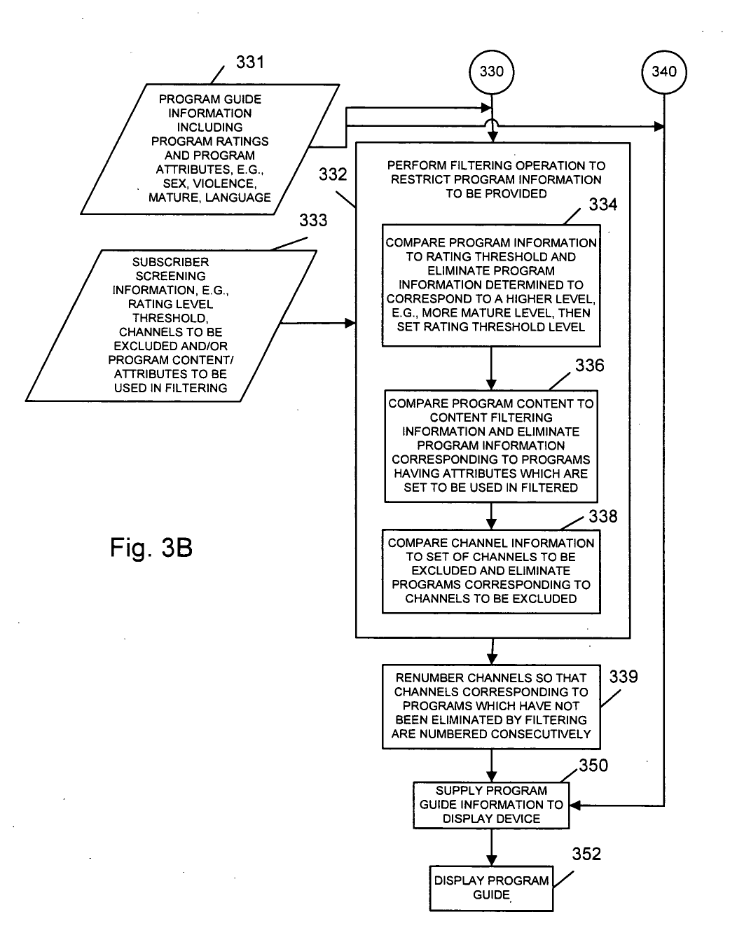

Operation of the exemplary STB 152 shown in FIG. 2 in accordance with the invention will now be described with reference to the flowchart 300 of FIG. 3. FIG. 3, which comprises the combination of FIGS. 3A and 3B illustrates the steps of providing access to program guide information in accordance with one exemplary embodiment of the invention which is implemented by the STB 152.

The method shown in FIG. 3 starts in step 302 with the main STB control module triggering the execution of a main routine included, e.g., in the module.

Operation proceeds from start step 302 to step 304 wherein the STB monitors for signals from the remote controls 156, 158. When a signal from a remote control is detected, the signal is processed starting in step 306. In step 306, the STB determines if the received signal is from a remote control device designated for use in obtaining a first level of access, e.g., unrestricted access, or a second level of access, e.g., a restricted level of access. This can be done in a variety of ways depending on the type of remotes used and the particular embodiments. Processing blocks 308 and 320 illustrate two alternative techniques, depending on the implementation for making the determination performed in step 306.

Processing block 308 is used where remotes of different types, e.g., which used different signals, are used in obtaining different levels of access, In step 310 of block 308, stored signal information, e.g., command sets 222, 228 is accessed with the different signal sets corresponding to the different types of remotes. Then, in step 312, the received signal is compared to the information obtained from the stored information and, based on the received signal matching a command from a first type remote or a second type remote, the type of remote used to send the command and the corresponding level of access to be provided is determined. Thus, in step 312, if it is determined the received signal matches a first type remote, it is determined that a first level of access to program information and programs is to be provided, e.g., an unrestricted level of access. However, if the signal matches a second type remote signal, it is determined in step 312 that a second level of access is to be provided to program information and programs, e.g., a restricted level of access.

As discussed above, processing block 320 which may be used when at least one of remote controls 156, 158 transmit an identifier along with a command such as a display program guide command. In block 320, as part of determining the level of access to be provided, it is determined if the received signal includes a remote control identifier corresponding to one of the first and second remotes 156, 158. In step 322, a remote control identifier is detected in the received signal. Then in step 324, stored information 224, 230 including lists of identifiers corresponding to remotes used to obtain the different levels of access is accessed. Next in steps 326 and 328 which can, but need not be, performed in parallel the detected identifier is compared to the identifier information included in memory 210. In step 326, the detected identifier is compared to remote control identifier designated for use in obtaining the first level of access and if there is a match, it is determined that the remote control is designated for use in obtaining the first level of access, e.g., unrestricted access. In step 328, the detected identifier is compared to remote control identifier designated for use in obtaining the second level of access and if there is a match, it is determined that the remote control is designated for use in obtaining the second level of access, e.g., restricted access.

With the particular level of access to be provided having been determined in step 306, operation proceeds via connecting node 330 to step 332 if it has been determined that the second, i.e., restricted, level of access is to be provided in response to the received signal so that filtering can be performed. Otherwise operation proceeds from step 306 to step 350 via connecting node 340.

In step 332, program guide information as well as subscriber screening information 333 is used to perform a filtering operation. Filtering module 218 may be called to perform the filtering implemented in step 332. Step 332 includes steps 334, 336, 338 which may be implemented serially but other orderings of the steps are also possible. In step 334, program information which may be presented is compared to a rating threshold included in the subscriber screening information 333 and programs having a rating corresponding to a more mature level than the threshold level are excluded from the program information which may be presented. Then in step 336, program attribute information from the set of program guide information 331 is compared to content information indicates indicating what programs should be eliminated based on content filtering, e.g., programs with a content indicated to be S would be eliminated from the guide information is the subscriber information indicated that programs with sexual content should be filtered out.

Then in step 338, filtering based on channel numbers is performed. If information 333 indicates that certain channels should be filtered out, e.g., because they do not correspond to a children's channel package, the program information for the channels to be eliminated is removed from the set of program guide information which is to be presented. Depending on the embodiment less or more filtering may be performed than shown in the exemplary filtering block 332.

Operation proceeds from step 332 to channel renumbering step 339. In channel renumbering step 339, channels remaining after the filtering process are renumbered consecutively, for use in a program guide and for channel access purposes, to help make the elimination of various channels and/or content less obvious. Operation proceeds from renumbering step 339 to output step 350 in which the program guide information remaining after processing is output to a display device.

In the case where a signal, e.g., a display program guide command, had been received from a remote control which was to be provided unrestricted access to program information and program content, operation would have bypassed the filtering step 332 and gone from step 306 to step 350 via connecting node 340. Thus, in the case of an access operation via the unrestricted remote 156, in step 150 an un-redacted set of program information would be output.

In step 352, the program information is displayed in the form of a program guide which can be viewed on the display device. The user may then select a program from the guide to view.

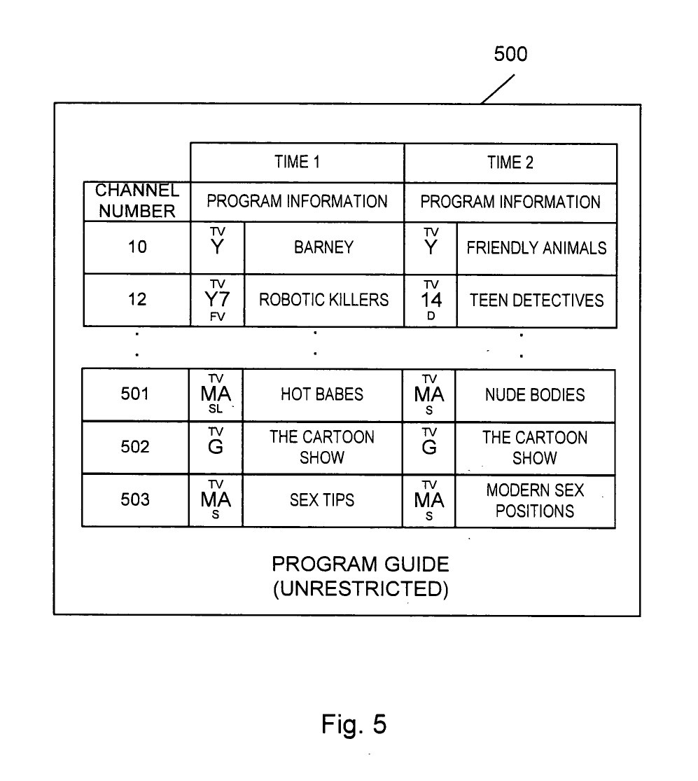

Exemplary program guides which may be generated and displayed in accordance with the invention are shown in FIGS. 5-8. FIG. 5 shows a program guide 500 displayed in response to a display guide command received from an unrestricted remote control 156. Note that the guide includes program information for multiple time periods, e.g., TIME 1 and TIME 2. In addition, channel number information is provided with the channels being listed in the order and using the number normally used by the cable operator. Thus, the channel numbers may be non-consecutive in the case where the subscriber does not subscribe to the full array of channels. Note that TV rating and content indicators are provided preceding the name of each program included in the guide. For example the program BARNEY, being a children's program with no content which may be considered objectionable by the rating organization is rate TV Y. However, the program ROBOTIC KILLERS is rated TV Y7 FV because of its slightly more mature content including fantasy violence. The program guide 500 includes programs with a wide range of ratings including a fair amount of adult material rated TV MA S because of its mature sexual content. The program SEX TIPS on channel 503 is one example of such an adult rated show.

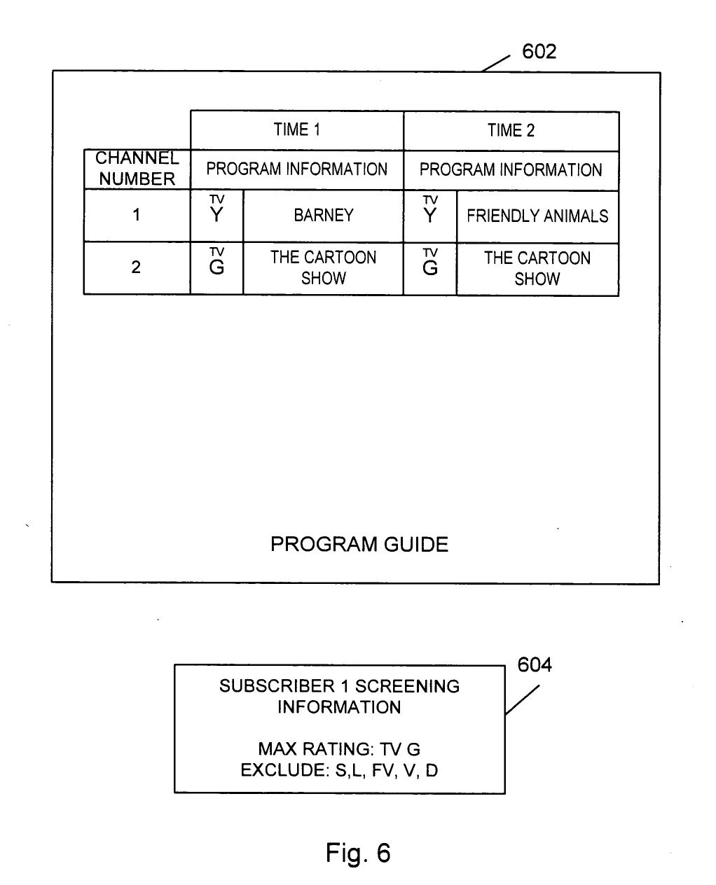

FIG. 6 shows the resulting exemplary program guide 602, assuming the same initial set of guide information shown in FIG. 5 was used, when the set top box is accessed using a restricted remote and the subscriber has set the screening information as indicated in box 604. Note that all programs from the display shown in FIG. 5 having a TV rating above G or including content designated with an S, L, FV, V or D have been eliminated and do not appear in the program guide 602. Also note that channels which have been deleted during to the elimination of the programs from the guide are omitted and the remaining channels have been renumbered consecutively as channels 1, 2.

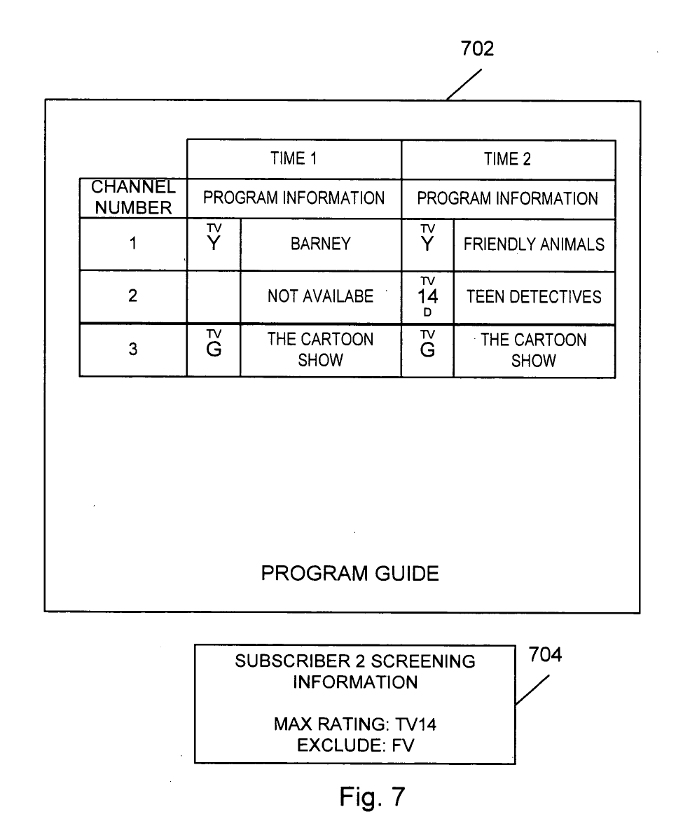

FIG. 7 shows the resulting exemplary program guide 702, assuming the same initial set of guide information shown in FIG. 5 was used, when the set top box is accessed using a restricted remote and the subscriber has set the screening information as indicated in box 704. Note that all programs from the display shown in FIG. 5 having a TV rating above TV 14 or including content designated with an FV have been eliminated and do not appear in the program guide 702. Note that filtering is on a per program level and, because one program remains on what is renumbered as channel 2, the channel is not eliminated altogether but the eliminated program “ROBOTIC KILLER” is simply listed as “NOT AVAILABLE” without any actual program information being provided in the place of the eliminated program. Also note that channels which have been deleted during to the elimination of the programs from the guide are omitted and the remaining channels have been renumbered consecutively as channels 1, 2, 3.

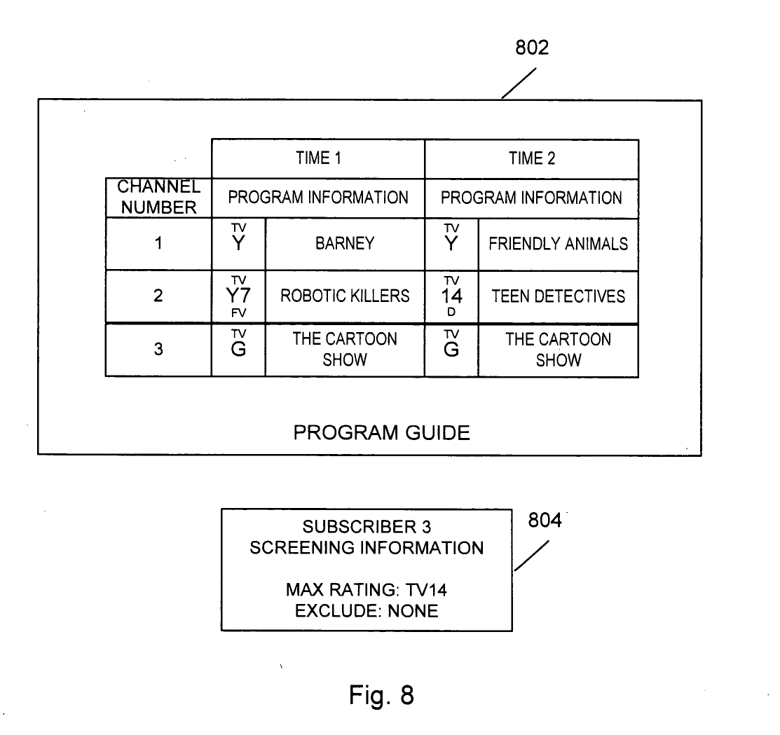

FIG. 8 shows the resulting exemplary program guide 802, assuming the same initial set of guide information shown in FIG. 5 was used, when the set top box is accessed using a restricted remote and the subscriber has set the screening information as indicated in box 804. Note that all programs from the display shown in FIG. 5 having a TV rating above TV 14 have been eliminated but that no filtering was performed on the content since no content restrictions were set by the subscriber. Also note that channels which have been deleted during to the elimination of the programs from the guide are omitted and the remaining channels have been renumbered consecutively as channels 1, 2, 3.

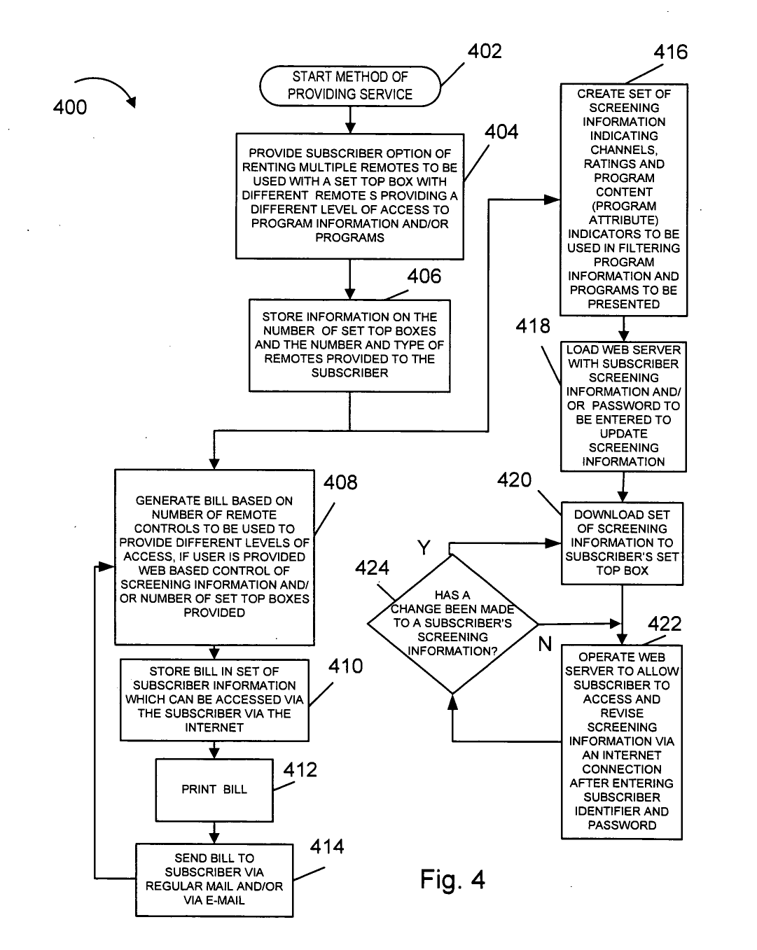

Having described the filtering and guide presentation methods of the invention above, a method of using the invention to provide a content and information delivery service will now be described with reference to the flowchart of FIG. 4. The flow chart 400 of FIG. 4 illustrates a method of providing a service and billing for the service in accordance with one exemplary embodiment of the invention. The method 400 may be implemented by the exemplary cable head end office 102 using one or more of the modules, servers and information stored therein.

The method 400 starts in step 402. Operation proceeds from step 402 to step 404 in which a service subscriber is provided with an option of renting multiple remotes, e.g., of different types, to be used with a set top box. The remotes of different types, in accordance with the invention may be used to provide different levels of access, e.g., with restricted remotes being used to provide as part of a premium or family oriented package, restricted access. Operation proceeds from step 404 to step 406 in which information on the number of set top boxes, remotes and the type of remotes rented to the subscriber is stored, e.g., for further use in billing operations. Operation proceeds from step 406 to steps 408 and 416 which may occur in parallel.

In step 416 a set of screening information indicating channels, rating and program content to be restricted when a set top box is accessed using a restricted remote is created. This may be done as part of an initial account set up process. Operation proceeds from step 416 to step 418 wherein the Web server 134 is loaded with the subscriber screening information. A password to be used for controlling access to the screening information via the Internet may also be stored in the Web server in step 418.

Operation proceeds from step 418 to step 420 wherein the set of restriction information to be used in filtering program information is downloaded to the subscriber's set top box 152.

Operation proceeds from step 420 to step 422 in which the Web server 134 is operated to allow the subscriber to access and revise screening information via an internet connection, e.g., after entering a subscriber identifier, used to identify the set of subscriber information, and/or password, used to control access to the information.

Operation proceeds from step 422 to step 424 wherein the Web server monitors to detect changes made to a subscriber's screening information. If a change has been made, operation proceeds to update step 420 otherwise operation continues at step 422 pending a change to the subscriber's screening information set.

Step 408 is the start of the billing processing branch of the method 400. In step 408, a bill is generated based on the number of remote controls which are provided to allow the user different levels of access, e.g., the number of type 1 and type 2 remotes, whether the subscriber is being provided with a Web based screening update feature and/or the number of set top boxes provided. Thus, users who choose multiple remotes of different types may be charged a premium over users who request remotes of only a single type, e.g., unrestricted remotes, since the users of the multiple remotes are being provided an enhanced service involving parental control and/or screening features not available with a single remote.

Next, in step 410 the generated bill is stored in a set of subscriber information which can be accessed by the subscriber via the Internet in one exemplary embodiment. Operation proceeds from step 410 to step 412 in which the generated bill is printed. Then in step 414 the bill is sent to the subscriber by regular postal mail and/or via E-mail. Operation proceeds from step 414 to step 408, e.g., as part of a monthly billing cycle with bills being generated and sent to the subscriber on a regular basis.

In various embodiments system elements described herein are implemented using one or more modules which are used to perform the steps corresponding to one or more methods of the present invention, for example, file compression, data rearrangement, file header generation, etc. Such modules may be implemented using software, hardware or a combination of software and hardware. Each step may be performed by one or more different software instructions executed by a processor, e.g., CPU.

At least one system implemented in accordance with the present invention includes a means for implementing the various steps which are part of the methods of the present invention. Each means may be, e.g., an instruction, processor, hardware circuit and/or combination of elements used to implement a described step.

Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more nodes. Accordingly, among other things, the present invention is directed to a machine-readable medium including machine executable instructions for causing a machine, e.g., processor and associated hardware, to perform one or more of the steps of the above-described method(s).

Numerous additional embodiments, within the scope of the present invention, will be apparent to those of ordinary skill in the art in view of the above description and the claims which follow.

What is claimed is:

1. An access control method for restricting access to program information, the method comprising:
receiving a signal from a remote control device;
determining if the signal was received from a remote control designated for use in obtaining a first level of access to program information or from a-remote control designated for use in obtaining a second level of access to program information, the second level of access to program information being a restricted level of access;
when it is determined that said signal was received from a remote control designated for use in obtaining the second level of access, performing a filtering operation to restrict the program information to be provided in response to said signal; and
when it is determined that said signal was received from a remote control designated to be provided said first level of access, providing access to program information without filtering out at least some program information which is filtered out by said filtering operation performed when a signal is received from a remote control designated for use in obtaining said second level of access.

2. The method of claim 1, wherein said step of determining if the signal was received from a remote control designated for use in obtaining a first level of access to program information or from a remote control designated for use in obtaining a second level of access to program information, the second level of access to program information being a restricted level of access includes:
determining if the received signal corresponds to a remote control of a first type or a remote control of a second type.

3. The method of claim 2, wherein determining if the received signal corresponds to a remote control of a first type or a remote control of a second type includes accessing signal information to determine if the received signal is a command from a first type remote or a command from a second type of remote, said first and second types of remote using different signals to implement the same command.

4. The method of claim 3, wherein said same command is a command to display a program guide and wherein said different signals are different infrared signals.

5. The method of claim 1, wherein said step of determining if the signal was received from a remote control designated for use in obtaining a first level of access to program information or from a remote control designated for use in obtaining a second level of access to program information, includes:
detecting a remote control identifier included in said signal; and
comparing the detected remote control identifier to a stored set of remote control identifiers including identifiers of remote controls designated for use in obtaining the first level of access.

6. The method of claim 1, wherein said step of determining if the signal was received from a remote control designated for use in obtaining a first level of access to program information or from a remote control designated for use in obtaining a second level of access to program information, includes:
detecting a remote control identifier included in said signal; and
comparing the detected remote control identifier to a stored set of remote control identifiers including identifiers of remote controls designated for use in obtaining the second level of access.

7. The method of claim 1, wherein performing a filtering operation to restrict the program information to be provided in response to said signal includes:
filtering program information based on program ratings information included in a set of program guide information.

8. The method of claim 7, wherein information corresponding to programs having a program rating above a set program rating level is filtered out.

9. The method of claim 7, wherein information corresponding to a guide rating are filtered at a sub-attribute level to filter out programs having a specific content.

10. The method of claim 9, wherein said filtering at a sub-attribute level is performed by comparing a sub-attribute indicator included in a program guide to information indicating content to be restricted.

11. The method of claim 10, wherein said information indicating content to be restricted indicates sexual content should be restricted.

12. The method of claim 11, wherein said information indicating content to be restricted indicates violent content should be restricted.

13. The method of claim 7, further comprising, when filtering is performed, the additional steps of:
generating a set of filtered program information, said set of filtered programming information excluding program information eliminated by said filtering process; and
supplying at least some of said set of filtered program information to a display device.

14. The method of claim 13, further comprising:
renumbering channels in said set of filtered program information so that channels associated with programs included in said set of filtered program information are consecutively numbered.

15. The method of claim 14, further comprising:
displaying the filtered program information on a display device as a program guide, said program guide including channel numbers assigned by said channel renumbering operation.

16. A device for providing access to program guide information, the device comprising:
a receiver for receiving a signal from a remote control device;
a control module for determining if the signal was received from a remote control designated for use in obtaining a first level of access to program information or from a remote control designated for use in obtaining a second level of access to program information, the second level of access to program information being a restricted level of access;
a filter module for use when it is determined that said signal was received from a remote control designated for use in obtaining the second level of access, said filtering module implementing a filtering operation to restrict the program information to be provided in response to said signal; and
means for providing a first level of access to program guide information when it is determined that said signal was received from a remote control designated to be provided said first level of access, said means for providing a first level of program access providing access to program information without filtering out at least some program information which is filtered out by said filtering operation performed when a signal is received from a remote control designated for use in obtaining said second level of access.

17. The apparatus of claim 16, wherein said control module includes:
means for determining if the received signal corresponds to a remote control of a first type or a remote control of a second type.

18. The apparatus of claim 17, wherein said apparatus includes stored signal information; and wherein
said means for determining if the received signal corresponds to a remote control of a first type or a remote control of a second type includes means for accessing signal information to determine if the received signal is a command from a first type remote or a command from a second type of remote, said first and second types of remote using different signals to implement the same command.

19. The apparatus of claim 18, wherein said same command is a command to display a program guide and wherein said different signals are different infrared signals.

20. The apparatus of claim 16, wherein said control module, includes:
a detection module for detecting a remote control identifier included in said signal; and
a comparison module for comparing the detected remote control identifier to a stored set of remote control identifiers including identifiers of remote controls designated for use in obtaining the first level of access.

21. A method of providing a service including providing controlled access to program guide information, the method comprising:
storing information indicating the number and type of remote controls rented to a service subscriber, at least two remote controls being rented to the service subscriber to provide different levels of access to program guide information depending on the remote control used at a particular point in time;
providing a set top box to the service subscriber which supports different levels of program guide information access depending on the remote control used to access said program guide information;
generating a bill for the service provided, said bill being a function of the number of remotes rented which are to provide a first level of program guide information access and the number of remotes rented to the subscriber to provide a second restricted level of program access.

22. The method of claim 11, further comprising:
downloading filtering information to the subscriber's set top box to be used in filtering program guide information provided in response to a command for program guide information from a remote control to be used for restricted program guide information access.

23. The method of claim 22, further comprising:
providing a Web service which said subscriber can connect to via the Internet;
allowing the subscriber to update the filtering information via the Internet; and
downloading updated filtering information to the set top box rented to the service subscriber.

24. The method of claim 33, further comprising:
generating a bill for an additional service subscriber which rents only remote controls which are provided the same level of access to program guide information; and
charging said additional service subscriber a lower rate than subscribers provided with multiple remotes to allow them to restrict program guide information access through the use of different physical remote controls.
